(19) United States
(12) Patent Application Publication
(10) Pub. No.: US 2021/0180447 A1
(43) Pub. Date: Jun. 17, 2021

(54) OPTIMIZED OPTICAL FIBER FOR ENHANCED SCATTER IN DOWNHOLE ENVIRONMENTS

(71) Applicants: Paul F. Wysocki, Blacksburg, VA (US); Dan Raymond Provenzano, Blacksburg, VA (US)

(72) Inventors: Paul F. Wysocki, Blacksburg, VA (US); Dan Raymond Provenzano, Blacksburg, VA (US)

(73) Assignee: Baker Hughes Oilfield Operations LLC, Houston, TX (US)

(21) Appl. No.: 16/717,040

(22) Filed: Dec. 17, 2019

(51) Int. Cl. E21B 47/12; G02B 6/02

(52) U.S. Cl. CPC E21B 47/123; G02B 6/02104; G02B 6/02119

(57) ABSTRACT

An apparatus for sensing a value of a property in a borehole having hydrogen gas penetrating a subsurface formation includes an optical fiber configured to be disposed in the borehole having the hydrogen gas and comprising a core having a fiber Bragg grating that is responsive to the value of the property and a cladding disposed about the core, wherein (i) the core is doped with a first dopant that is photo-sensitive for writing the fiber Bragg grating and that has a concentration in the core of 2 Mole % or less and (ii) the cladding is doped with a second dopant that lowers an index of refraction of the cladding.

### BACKGROUND

Boreholes are drilled into earth formations for various purposes such as hydrocarbon production, geothermal production, and carbon dioxide sequestration. A sensor for measuring a downhole property such as pressure and temperature may be disposed in a borehole in order to provide data useful in a process or operation for utilizing the earth formation. The environment to which the sensor is exposed can be quite hazardous due to the high pressures and temperatures that may be experienced downhole. Typically, a sensor using an optical fiber may be used in this environment. Unfortunately, optical fibers exposed to significant hydrogen gas at high temperatures can cause these optical fibers to darken and impede optical transmission thus preventing their use as sensors in this environment. Hence, it would be well received in industries making use of the earth formations if optical fibers for sensing applications for measuring one or more properties downhole were developed to withstand the downhole environment and still provide accurate measurements.

### BRIEF SUMMARY

Disclosed is an apparatus for sensing a value of a property in a borehole having hydrogen gas penetrating a subsurface formation. The apparatus includes an optical fiber configured to be disposed in the borehole having the hydrogen gas and comprising a core having a fiber Bragg grating that is responsive to the value of the property and a cladding disposed about the core, wherein (i) the core is doped with a first dopant that is photo-sensitive for writing the fiber Bragg grating and that has a concentration in the core of 2 Mole % or less and (ii) the cladding is doped with a second dopant that lowers an index of refraction of the cladding.

Also disclosed is a method for sensing a value of a property in a borehole having hydrogen gas penetrating a subsurface formation. The method includes disposing an optical fiber in the borehole having the hydrogen gas, the optical fiber comprising a core having a fiber Bragg grating that is responsive to the value of the property and a cladding disposed about the core, wherein (i) the core is doped with a first dopant that is photo-sensitive for writing the fiber Bragg grating and that has a concentration in the core of 2 Mole % or less and (ii) the cladding is doped with a second dopant that lowers an index of refraction of the cladding. The method also includes interrogating the fiber Bragg grating with light using an optical interrogator optically coupled to the optical fiber to determine the value of the property.

### BRIEF DESCRIPTION OF THE DRAWINGS

The following descriptions should not be considered limiting in any way. With reference to the accompanying drawings, like elements are numbered alike:

FIG. 1 is a cross-sectional view of an embodiment of a fiber optic sensor disposed in a borehole penetrating the earth;

FIG. 2 depict aspects of an optical fiber;

FIG. 3 illustrates index of refraction versus GeO2 concentration in fused silica;

FIG. 4 illustrates index of refraction versus F concentration in fused silica;

FIG. 5 illustrates hydrogen induced loss in conventional optical fibers having FBGs in high temperature downhole conditions;

FIG. 6 illustrates hydrogen induced loss in pure silica core fibers in high temperature downhole conditions;

FIGS. 7-10 depict aspects of different embodiments of the optical fiber having enhanced scatter and hydrogen resistant properties; and

FIG. 11 is a flow chart for a method for sensing a value of a property in a borehole having hydrogen gas penetrating a subsurface formation.

### DETAILED DESCRIPTION

A detailed description of one or more embodiments of the disclosed apparatus and method presented herein by way of exemplification and not limitation with reference to the figures.

Disclosed are embodiments of apparatuses and methods for sensing a property in a borehole penetrating the earth. The apparatuses and methods involve using an optical fiber sensor made of glass in order to withstand a harsh downhole environment having high pressures, which can be thousands of pounds per square inch (psi) and high temperatures that can exceed 200° C. in addition to containing a significant concentration of hydrogen gas at the high temperatures.

When utilizing optical fiber for remote sensing, several approaches depend on detecting distributed scattering from the optical fiber. This includes distributed acoustic sensing (DAS), distributed temperature sensing (DTS), optical frequency domain reflectometry (OFDR), and optical time domain reflectometry (OTDR) in non-limiting embodiments. To increase the optical signal quality received by an optical interrogator disposed at the surface, it is beneficial to enhance the backscattering optical signal magnitude by increasing the scattering in the optical fiber. It is possible to make fiber scatter more by adding particles, but this also increases loss because scattering by particles goes out in all directions, not just backwards towards the optical interrogator. However, it is possible to increase scattering directionally, mostly in the backward direction, by adding fiber Bragg gratings (FBGs). Ideally, such backwards scattering FBGs are broadband, enhancing scattering over a wide range of wavelengths, wide enough to include all wavelengths to be used in remotely probing the scattering to include desired resolution and dynamic range. Such FBGs are typically written in conventional silica glass optical fibers containing germanium and/or phosphorous dopant, which make the glass photosensitive, by exposing those fibers to ultraviolet light. Such conventional optical fibers having FBGs typically contain several percent GeO2 in SiO2 to be highly photosensitive.

Unfortunately, hydrogen reacts with defects in germanium containing fibers to darken the fiber and impede optical transmission. This limits dramatically the length of any Germanium (Ge) doped grating fiber that can be used in such applications. In order to avoid this issue, “pure-core” silica fibers have been developed that contain no germanium but rather utilized Fluorine (F) doping in the cladding to create a guide. Unfortunately, such fibers are not photosensitive and thus cannot include FBGs.

The application for FBGs in enhancing scattering is unique as compared with other conventional FBGs in that the unique FBGs needed for enhanced scattering can be extremely weak to still be effective. Fiber scattering is generally at a level or −90 dB/mm meaning 10 e-9 of light is scattered per mm of fiber. The enhanced scattering can be effective if it just increases the scattering to 20 dB higher level, or −70 dB/mm. Conventional FBGs in general for other applications reflect 0.001 to 100% of light (−50 dB to 0 dB) and are a few millimeters long. To make the unique FBGs at only −70 dB strength requires far less germanium in the glass fiber than is required to reach −50 dB reflectivity or greater.

So, to reduce sensitivity to hydrogen degradation in oil and gas applications while still adequately enhancing scattering to improve DAS, DTS or other sensing systems, a glass fiber can be made with ten times (10×) or even one hundred times (100×) less germanium than standard conventional FBG fiber. But, such a glass fiber still needs to have high enough index difference to guide light (Germanium also serves this role in FBG fibers). So, a fiber based on a pure-core design (with Fluorine in the cladding to make an index difference) but with a very small amount of germanium added to the “pure-core” will ideally meet all the needs for enhanced scattering for sensing in hydrogen rich environments in oil and gas. The term “very small” here relates to at least ten times less germanium or other dopant as compared to the amount of dopant used in convention optical fibers for writing FBGs.

The optical sensing fiber described herein is unique. Conventional “pure-core” fiber for oil and gas use Fluorine down-doping (i.e., to lower the index of refraction) of the cladding to avoid all germanium doping (and phosphorus as well) to avoid any hydrogen sensitivity and so cannot write FBGs using UV light. On the other hand, fibers available for FBG writing contain 2% or more germanium by weight in the core to write strong FBGs for typical applications. Optical fibers with 0.1% Germanium or less by weight are not useful for making conventional strong FBGs. In one or more embodiments, the optical fiber sensor disclosed herein includes a silica core with a very small amount of germanium with an index of refraction slightly above that of pure silica, generally 1.444. The germanium level can be between 0.001 and 0.1% by volume. It also includes a cladding with Fluorine down-doping that is similar to that of pure-core fibers with the index generally down at 1.440. In one or more embodiments, the optical fiber sensor disclosed herein has a numerical aperture of about 0.1. The numerical aperture (NA) represents the guiding capability of an optical fiber and can be written as a function of the index of refraction of the core (n_{core}) and the index of refraction of the cladding (n_{cladding}). It is desired to maintain the NA above 0.1 to achieve good guidance. Lower NA fibers can theoretically guide light, but in practice suffer from forms of stress and bend induced loss that make them impractical for use in long lengths (e.g., several kilometers).

NA=√(n²_{core}−n²_{cladding})

The unique optical fiber sensor reduces hydrogen sensitivity by reducing germanium but leaves enough photosensitivity to write FBGs of low strength and, thus, enables use in high concentrations of hydrogen gas downhole.

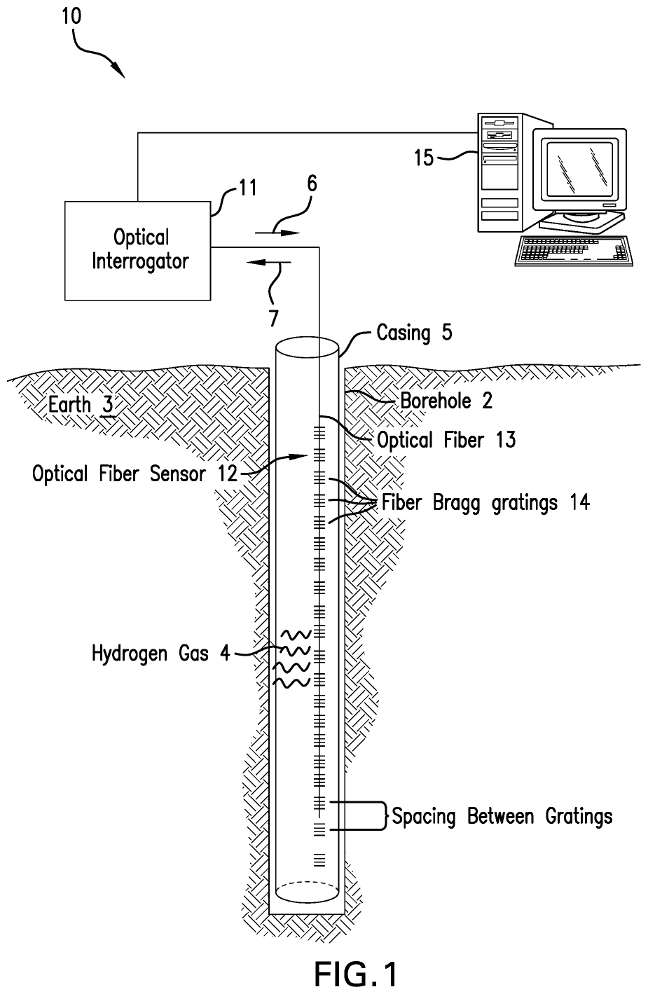

The unique optical fiber sensor and its applications are now discussed in more detail. FIG. 1 illustrates a simplified schematic diagram of an optical distributed sensing system 10. The optical sensing system 10 includes an optical interrogator 11 in optical communication with an optical fiber sensor 12. The optical fiber sensor 12 is an optical fiber 13 that includes a series of sensors referred to as fiber Bragg gratings 14. Each fiber Bragg grating 14 is configured to act as a filter to reflect a fraction of incoming light at or near a resonant frequency characteristic of the fiber Bragg grating and to let the light of the other frequencies pass. Imposing a force or temperature change on the grating will cause the grating to distort and cause a shift in the resonant wavelength (or corresponding frequency). By measuring the amount of the shift, the amplitude of the force or parameter causing the force, such as mechanical strain or change in temperature, can be measured. For example, the following equation may be used to correlate the shift in resonant wavelength to an applied strain or a change in temperature of the grating:

[ΔλB/λB]=(1−pe)ϵ+(αΛ+αn)ΔT

where ΔλB/λB is the relative shift in the Bragg wavelength due to an applied strain (ϵ) and a change in temperature (ΔT), p e is the strain optic coefficient, αΛ is the thermal expansion coefficient of the optical fiber, and a n is the thermo-optic coefficient. The distance between adjacent FBGs in a sensor array is dependent on several variables and one of skill in the art would understand how to select the proper spacing for the processing technique being used and the desired application. In one or more embodiments, all of the FBGs in one optical fiber in the present disclosure are written at the same wavelength (i.e., have the same optical reflective properties) and at a relatively low reflective strength (or reflectivity) and use Optical Frequency Domain Reflectometry (OFDR) to interrogate them all. In contrast, in many conventional distributed optical sensing systems, the FBGs are written at different wavelengths and have a relatively higher reflective strength (e.g., at least 100 times higher) and may be interrogated by a frequency multiplexed interrogator.

Non-limiting embodiments of the types of measurements performed by the fiber Bragg gratings include pressure, temperature, strain, force, acceleration, vibrations, shape, and chemical composition. The FBG is naturally sensitive to either strain or temperature changes. For the measurement of other parameters, a transducer may be required to convert the parameter of interest into either a strain or temperature change. In non-limiting embodiments, the length of each fiber Bragg grating may be in a range of from a few millimeters to about two centimeters depending on the desired response characteristics of the gratings.

The optical fiber sensor 12 in FIG. 1 is shown affixed to a casing 5 that is disposed in a borehole 2 penetrating the earth 3, which may represent a subsurface formation. The borehole includes a concentration of hydrogen gas 4 that can degrade optical transmission in conventional optical fibers having FBGs. The casing 5 represents any equipment, structure, apparatus, or material that the optical fiber sensor 12 may be used to perform measurements on. Additionally, environmental conditions in the borehole may be monitored or measured using the optical fiber sensor 12.

The optical interrogator 11 is configured to measure the shift in the resonant wavelength (or corresponding resonant frequency), if any, in each fiber Bragg grating and to determine the location in the optical fiber of each fiber Bragg grating being interrogated. In a frequency multiplexed interrogator system, the location of a particular FBG is often known only by noting the original location of the FBG with a wavelength near the measured value. In order to measure the resonant wavelength shifts and grating locations, the optical interrogator 11 is configured to transmit input light 6 into the optical fiber 12 and to receive reflected light 7, which may also be referred to as an optical signal. The transmitted input light 6 and the reflected light 7 are transmitted and processed in accordance with any of the methods known in the art such as Optical Frequency Domain Reflectometry (OFDR), Incoherent Optical Frequency Domain Reflectometry (IOFDR), or broadband reflectometry with frequency-domain multiplexing in non-limiting embodiments. In the case of frequency-domain multiplexing, different FBGs must be resonant at different wavelengths in order to interrogate all of them at once.

Still referring to FIG. 1, a computer processing system 15 is coupled to the optical interrogator 11. The computer processing system 15 is configured to process the reflected light 7. For example, the computer processing system 15 can perform a fast Fourier transform (FFT) on received reflected light 7. Further, the computer processing system 15 can convert the magnitude of the resonant frequency shift into a parameter of interest such as temperature or strain for example using a mathematical relationship between parameter and the magnitude of the resonant frequency shift. The mathematical relationship can be determined by analysis and/or testing. The computer processing system 15 can be standalone or incorporated into the optical interrogator 11. Once the values of the parameter of interest are determined, it can be displayed to a user via a display or printer, it can be recorded for future use, or it can be input into an algorithm requiring that parameter for execution.

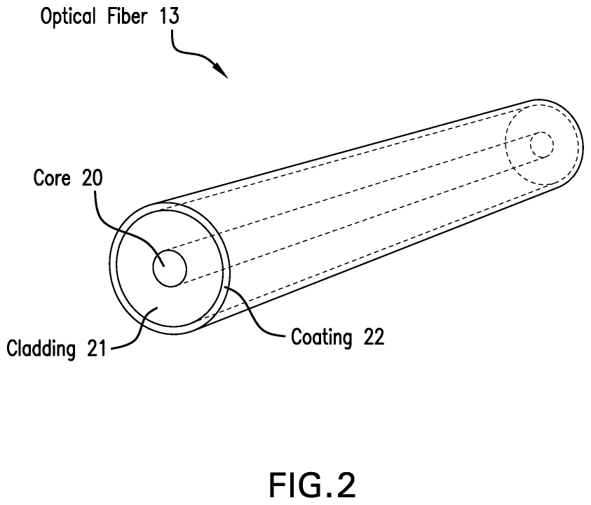

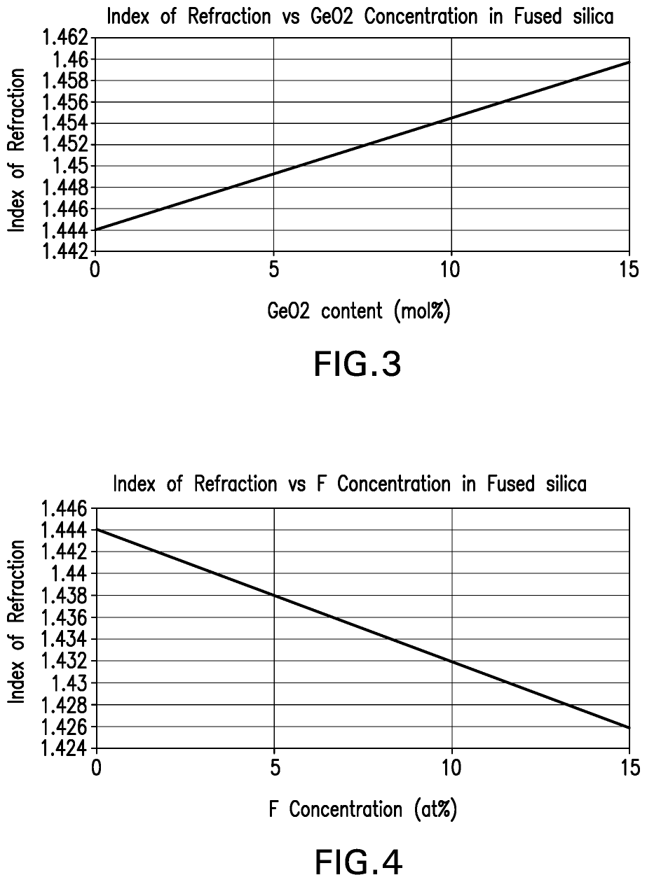

FIG. 2 depicts aspects of the optical fiber 13. The optical fiber 13 includes a core 20, a cladding 21, and a coating 22. The coating 22 is configured to provide protection to the optical fiber 13 in the downhole environment. The core 20 has an index of refraction that is greater than the index of refraction of the cladding 21 in order to guide the transmitted light and the reflected light along the optical fiber 13. In one or more embodiments, the core 20 is doped with a very small amount of GeO2 to enable writing the FBGs and to raise its index of refraction, while the cladding 21 is down-doped to lower its index of refraction. FIG. 3 illustrates the index of refraction of fused silica versus GeO2 concentration of the fused silica. FIG. 4 illustrates the index of refraction of the fused silica versus F concentration of the fused silica. As can be seen in FIGS. 3 and 4, a very small concentration of GeO2 can raise the index of refraction of the core 20 to slightly above the index of refraction of pure silica such as for example to 1.44455, while a concentration of F of about 5 at % provides an index of refraction of approximately 1.43799. Thus, the small concentration of GeO2 provides for (1) an adequate index of refraction for guiding light in the core 20 and (2) enabling the writing of weak FBGs in the optical fiber 13.

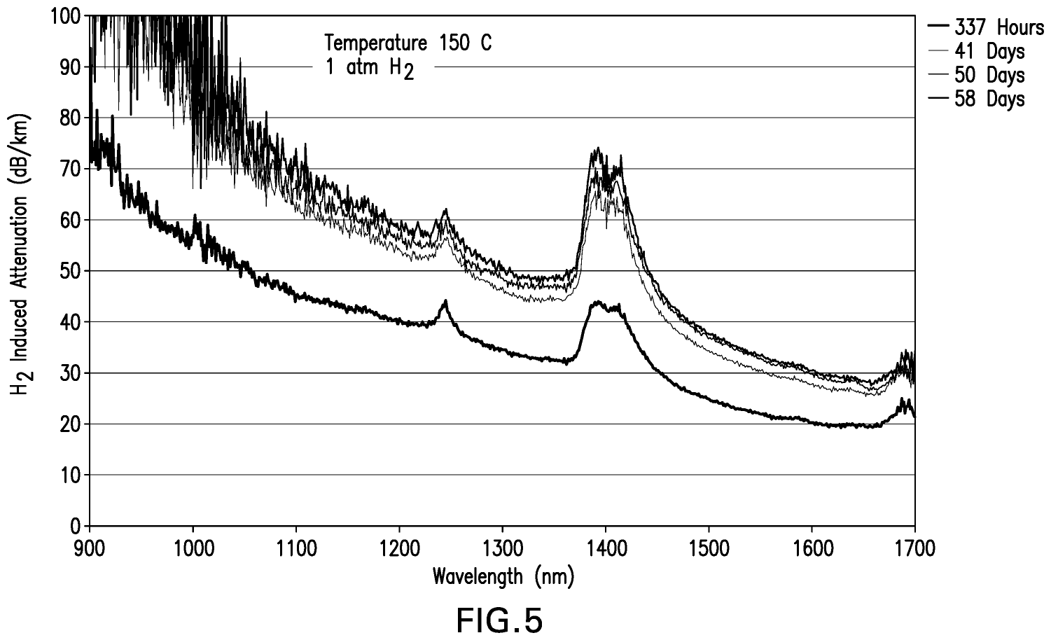

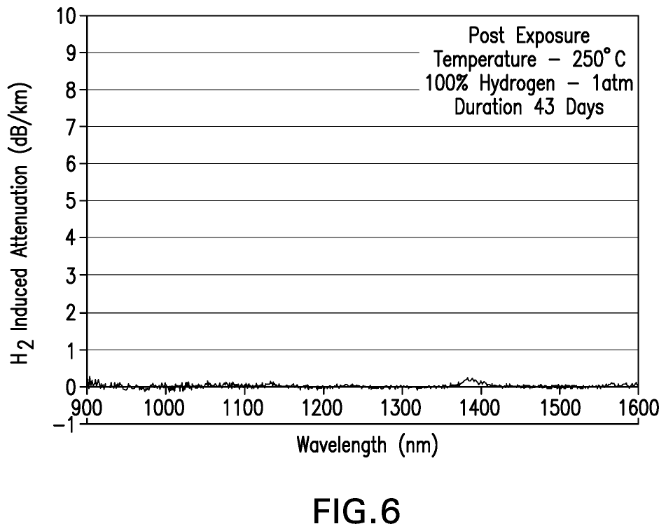

In addition, the small concentration of GeO2 in the core 20 enables the optical fiber 13 to withstand high hydrogen gas levels at high temperatures downhole. FIG. 5 illustrates hydrogen induced loss in conventional optical fibers having FBGs in high temperature downhole conditions. FIG. 6 illustrates hydrogen induced loss in pure silica core fibers in high temperature downhole conditions showing very little to no loss over a range of wavelengths. From these two figures, it can be seen that it is possible to design a fiber with substantially less Germanium and still achieve the desired enhancement of the scattering by writing FBGs. For example, to enhance the scattering by 400 times (400×), which is a 26 dB increase, a 5 mm long FBG would have to be −68 dB in strength, which is 18 dB lower than the typical conventional −50 dB FBG. The strength of an FBG is about proportional to the amount of Germanium in the fiber for low germanium levels. To lower the FBG strength by 18 dB would then require a reduction of the Germanium by a factor of 63. So, the 14 mole % Ge of a typical conventional FBG optical fiber could be reduced to about 0.22 mole % Ge and produce the desired FBG. The advantage of this approach is that the fiber sensitivity to hydrogen is also reduced by a factor 63, meaning the 30 dB/km loss increase shown in FIG. 5 would be less than 0.5 dB/km increase in such a fiber. Of course, this little germanium by itself would not produce a very good optical guide in the FBG fiber design. Thus, the use of Fluorine doped cladding combined with this small amount of germanium to can be used produce the enhanced scatter fiber with good guiding properties, low hydrogen susceptibility and adequate FBG writing capabilities. One example has 0.5 Mole % of GeO2, which only slightly raises the index from pure silica, and would produce about 1 dB/km of loss at 1550 nm if scaled from FIG. 5. As disclosed herein, no Germanium level more than 2 Mole % would be acceptable in a hydrogen rich downhole environment for several kilometer sensing lengths. Accordingly, a Germanium level of 2 Mole % or less is acceptable for a high temperature hydrogen rich downhole environment for sensing applications requiring two or more kilometers of sensing optical fiber.

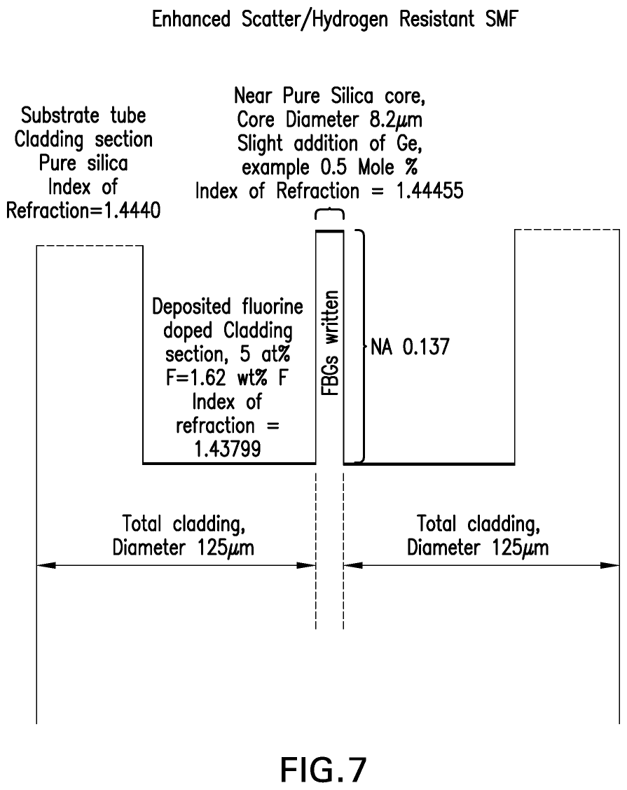

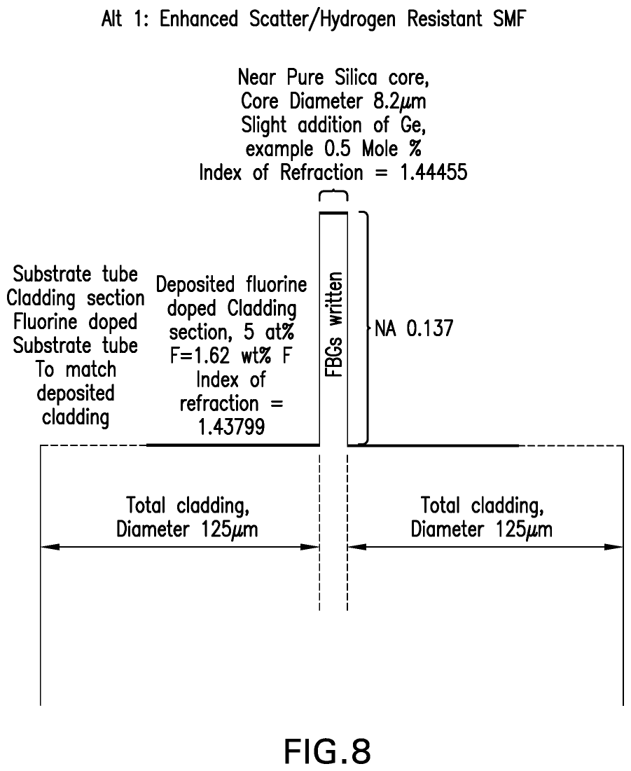

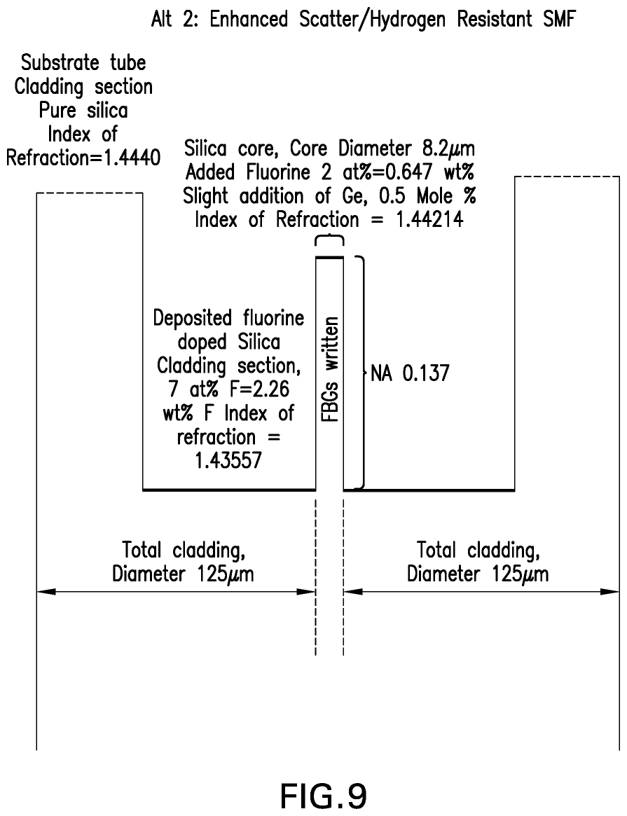

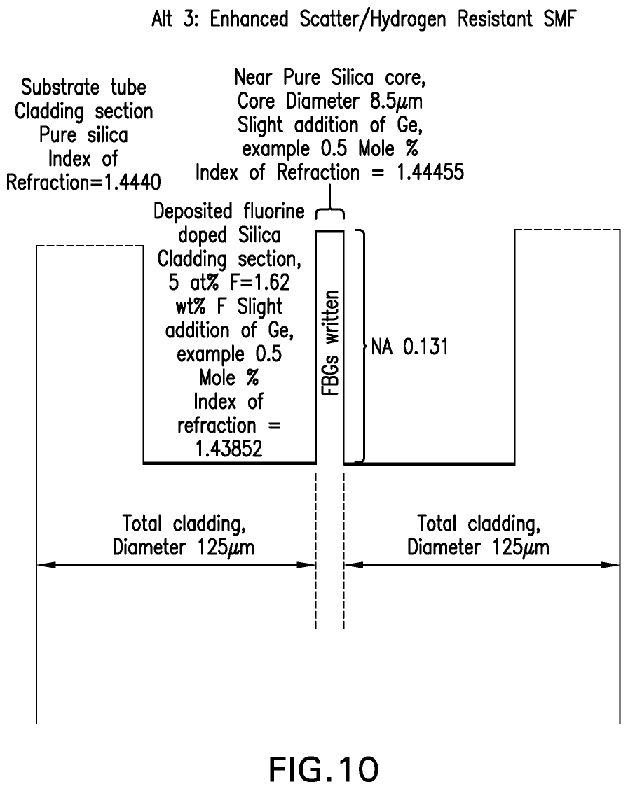

FIGS. 7-10 depict aspects of different embodiments of the optical fiber 13 having enhanced scatter and hydrogen resistant properties. In these figures, the horizontal axis represents a diameter through a cross-section of the optical fiber 13 and the vertical axis represents the corresponding index of refraction. The substrate tube cladding section in these figures relates to an outer annulus of the cladding adjacent to the coating of the optical fiber 13. In these embodiments, the substrate tube cladding section does not include a dopant. In the embodiment of FIG. 9, the core is doped with two elements, Germanium and Fluorine. At low dopant levels, the optical effects of the dopants add approximately linearly so the index of refraction can be calculated by adding or subtracting their effects as appropriate based on their concentrations. For example, n(1550 nm)=1.444024+0.001046GeO2_{Mol %}−0.001210F_{At %} where the GeO2 and F concentrations are given in Mol % and At %, respectively.

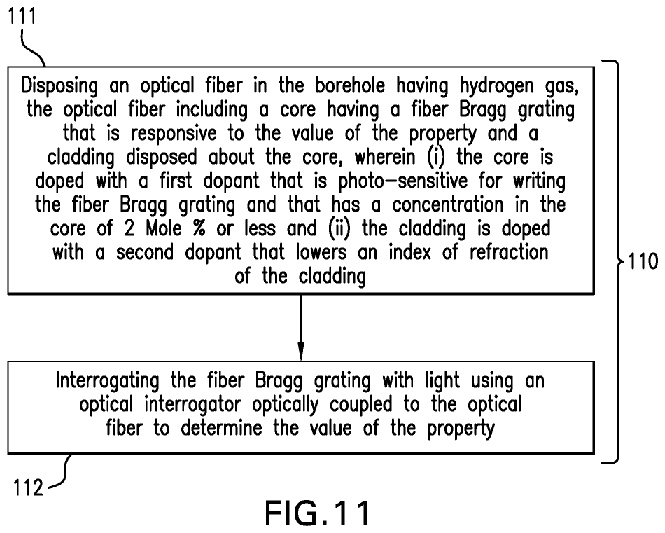

FIG. 11 is a flow chart for a method 110 for sensing a value of a property in a borehole having hydrogen gas penetrating a subsurface formation. Block 111 calls for disposing an optical fiber in the borehole having the hydrogen gas, the optical fiber comprising a core having a fiber Bragg grating that is responsive to the value of the property and a cladding disposed about the core, wherein (i) the core is doped with a first dopant that is photo-sensitive for writing the fiber Bragg grating and that has a concentration in the core of 2 Mole % or less and (ii) the cladding is doped with a second dopant that lowers an index of refraction of the cladding.

Block 112 calls for interrogating the fiber Bragg grating with light using an optical interrogator optically coupled to the optical fiber to determine the value of the property.

The method 110 may also include disposing at least two kilometers, three kilometers, or four kilometers of the optical fiber into the borehole.

While for teaching purposes Germanium is discussed as a photo-sensitive dopant to write the FBGs and raise the index of refraction in the core and Fluorine is discussed as a down-dopant for lowering the index of refraction of the cladding, it can be appreciated that other dopants may also be used either individually or in combination. For example, Phosphorous and/or aluminum may be used in place of or in combination with Germanium in very small amounts to prevent hydrogen degradation and still enable the writing of weak FBGs, while Boron may be used in place of or in combination with Fluorine for down-doping.

Set forth below are some embodiments of the foregoing disclosure:

Embodiment 1: An apparatus for sensing a value of a property in a borehole having hydrogen gas penetrating a subsurface formation, the apparatus comprising: an optical fiber configured to be disposed in the borehole having the hydrogen gas and comprising a core having a fiber Bragg grating that is responsive to the value of the property and a cladding disposed about the core, wherein (i) the core is doped with a first dopant that is photo-sensitive for writing the fiber Bragg grating and that has a concentration in the core of 2 Mole % or less and (ii) the cladding is doped with a second dopant that lowers an index of refraction of the cladding.

Embodiment 2: The apparatus according to any previous embodiment, wherein the first dopant is at least one of Germanium, Phosphorous, and Aluminum.

Embodiment 3: The apparatus according to any previous embodiment, wherein the second dopant is at least one of Fluorine and Boron.

Embodiment 4: The apparatus according to any previous embodiment, wherein a numerical aperture of the optical fiber is in a range of 0.10 to less than 0.14.

Embodiment 5: The apparatus according to any previous embodiment, wherein light scattering of the fiber Bragg grating is in a range of −70 db/mm to less than −50 db/mm.

Embodiment 6: The apparatus according to any previous embodiment, wherein the light scattering of the fiber Bragg grating is 20 db/mm greater than natural light scattering from the optical fiber without the fiber Bragg grating.

Embodiment 7: The apparatus according to any previous embodiment, wherein the optical fiber comprises silica.

Embodiment 8: The apparatus according to any previous embodiment, wherein the optical fiber is at least two kilometers long.

Embodiment 9: The apparatus according to any previous embodiment, wherein the optical fiber is at least three kilometers long.

Embodiment 10: The apparatus according to any previous embodiment, wherein the optical fiber is at least four kilometers long.

Embodiment 11: The apparatus according to any previous embodiment, further comprising an optical interrogator optically coupled to the optical fiber and configured to interrogate the fiber Bragg grating with light to determine the value of the property.

Embodiment 12: The apparatus according to any previous embodiment, wherein the fiber Bragg grating comprises a plurality of fiber Bragg gratings.

Embodiment 13: The apparatus according to any previous embodiment, wherein the optical fiber is coupled to a structure disposed in the borehole.

Embodiment 14: A method for sensing a value of a property in a borehole having hydrogen gas penetrating a subsurface formation, the method comprising: disposing an optical fiber in the borehole having the hydrogen gas, the optical fiber comprising a core having a fiber Bragg grating that is responsive to the value of the property and a cladding disposed about the core, wherein (i) the core is doped with a first dopant that is photo-sensitive for writing the fiber Bragg grating and that has a concentration in the core of 2 Mole % or less and (ii) the cladding is doped with a second dopant that lowers an index of refraction of the cladding; and interrogating the fiber Bragg grating with light using an optical interrogator optically coupled to the optical fiber to determine the value of the property.

Embodiment 15: The method according to any previous embodiment, wherein the property comprises at least one of temperature, pressure, vibrations, strain, and acoustic sound.

Embodiment 16: The method according to any previous embodiment, further comprising disposing at least two kilometers, three kilometers, or four kilometers of the optical fiber into the borehole.

In support of the teachings herein, various analysis components may be used, including a digital and/or an analog system. For example, the optical interrogator 11 and/or the computer processing system 15 may include digital and/or analog systems. The system may have components such as a processor, storage media, memory, input, output, communications link (wired, wireless, optical or other), user interfaces (e.g., a display or printer), software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply, magnet, electromagnet, sensor, electrode, transmitter, receiver, transceiver, antenna, controller, optical unit or components, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured. The terms “first,” “second” and the like are used to differentiate elements and are not intended to denote a particular order.

The flow diagram depicted herein is just an example. There may be many variations to this diagram or the steps (or operations) described therein without departing from the scope of the invention. For example, operations may be performed in another order or other operations may be performed at certain points without changing the specific disclosed sequence of operations with respect to each other. All of these variations are considered a part of the claimed invention.

The disclosure illustratively disclosed herein may be practiced in the absence of any element which is not specifically disclosed herein.

While one or more embodiments have been shown and described, modifications and substitutions may be made thereto without departing from the scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for sensing a value of a property in a borehole having hydrogen gas penetrating a subsurface formation, the apparatus comprising:
an optical fiber configured to be disposed in the borehole having the hydrogen gas and comprising a core having a fiber Bragg grating that is responsive to the value of the property and a cladding disposed about the core, wherein (i) the core is doped with a first dopant that is photo-sensitive for writing the fiber Bragg grating and that has a concentration in the core of 2 Mole % or less and (ii) the cladding is doped with a second dopant that lowers an index of refraction of the cladding.

2. The apparatus according to claim 1, wherein the first dopant is at least one of Germanium, Phosphorous, and Aluminum.

3. The apparatus according to claim 1, wherein the second dopant is at least one of Fluorine and Boron.

4. The apparatus according to claim 1, wherein a numerical aperture of the optical fiber is in a range of 0.10 to less than 0.14.

5. The apparatus according to claim 1, wherein light scattering of the fiber Bragg grating is in a range of −70 db/mm to less than −50 db/mm.

6. The apparatus according to claim 5, wherein the light scattering of the fiber Bragg grating is 20 db/mm greater than natural light scattering from the optical fiber without the fiber Bragg grating.

7. The apparatus according to claim 1, wherein the optical fiber comprises silica.

8. The apparatus according to claim 1, wherein the optical fiber is at least two kilometers long.

9. The apparatus according to claim 8, wherein the optical fiber is at least three kilometers long.

10. The apparatus according to claim 9, wherein the optical fiber is at least four kilometers long.

11. The apparatus according claim 1, further comprising an optical interrogator optically coupled to the optical fiber and configured to interrogate the fiber Bragg grating with light to determine the value of the property.

12. The apparatus according to claim 1, wherein the fiber Bragg grating comprises a plurality of fiber Bragg gratings.

13. The apparatus according to claim 1, wherein the optical fiber is coupled to a structure disposed in the borehole.

14. A method for sensing a value of a property in a borehole having hydrogen gas penetrating a subsurface formation, the method comprising:
disposing an optical fiber in the borehole having the hydrogen gas, the optical fiber comprising a core having a fiber Bragg grating that is responsive to the value of the property and a cladding disposed about the core, wherein (i) the core is doped with a first dopant that is photo-sensitive for writing the fiber Bragg grating and that has a concentration in the core of 2 Mole % or less and (ii) the cladding is doped with a second dopant that lowers an index of refraction of the cladding; and
interrogating the fiber Bragg grating with light using an optical interrogator optically coupled to the optical fiber to determine the value of the property.

15. The method according to claim 14, wherein the property comprises at least one of temperature, pressure, vibrations, strain, and acoustic sound.

16. The method according to claim 14, further comprising disposing at least two kilometers, three kilometers, or four kilometers of the optical fiber into the borehole.
